(19) United States
(12) Patent Application Publication
(10) Pub. No.: US 2003/0078101 A1
(43) Pub. Date: Apr. 24, 2003

(54) Player specific game system

(75) Inventors: Richard J. Schneider, Las Vegas, NV (US); Floyd W. Glisson, Las Vegas, NV (US); R. Jeffrey Jordan, Henderson, NV (US)

Correspondence Address: MARGER JOHNSON & MCCOLLOM PC, 1030 SW MORRISON STREET, PORTLAND, OR, 97205, US

(73) Assignee: Acres Gaming Incorporated, Las Vegas, NV

(21) Appl. No.: 10/247,786

(22) Filed: Sep. 18, 2002

Related U.S. Application Data
(60) Provisional application No. 60/323,499, filed on Sep. 18, 2001.

(51) Int. Cl. A63F 9/24; G06F 17/00

(52) U.S. Cl. 463/42

(57) ABSTRACT

Embodiments of the invention provide a game tailoring system that allows a gaming experience to be tailored to an individual player. Player data is tracked as an identified player plays at a gaming device. Additionally, other types of data, such as retail purchases, preferences, and experience are stored. The data is analyzed and triggering levels set which, when satisfied, cause the game tailoring system to modify the gaming experience. The triggering levels can be different for different players. Additionally, data about groups of players or groups of gaming devices can be tracked, stored, and used as reward triggers. Further, depending on the identified player or a group of selected machine, embodiments of the invention can cause messages, graphics,, or animations to appear on the game screen.

### CROSS REFERENCE TO RELATED APPLICATIONS

This application claims priority from provisional application U.S. Ser. No. 60/323,499 titled “Interactive gaming device system”, filed Sep. 18, 2001, the contents of which are hereby incorporated herein for all purposes.

### TECHNICAL FIELD

This disclosure relates to networked gaming devices, and, more specifically, to a networked gaming system able to change game content and behavior based on recorded data about game players.

### BACKGROUND OF THE INVENTION

To secure a sustainable competitive advantage, casino operators must perform a superior job of attracting new patrons, retaining existing patrons, and stimulating game play. Three broad methodologies adopted by casino operators in some combination to achieve these goals have historically included gaming environment, types of games or gaming devices, and incentive programs.

Providing a casino environment that encourages visitation by the target patron market segment includes providing an aesthetically pleasing, comfortable casino environment in a favorable location with attractive ancillary facilities such as restaurants, movie theatres, hotels, water parks, fountains, volcanoes, shows, etc. Providing good customer service is also an element of having a good environment.

Providing desirable slot machines and table games that satisfy players' unique gambling tastes and provide a competitive rate of return is likewise important.

Additionally, modern casinos use various incentive programs that are usually administered in some fashion by an on-line player management/bonusing system. Examples of such incentive programs include, for example, comps, player points for play, loyalty bonuses such as Return Play™, system bonuses such as mystery jackpots, or multiplied jackpot time, short term casino promotions of all types such as: direct mail, cash offers, Match Play offers, drawings, and food, hotel, and merchandise giveaways.

Each of these approaches has corresponding limitations. For instance, with regard to environment, facilities are expensive to create, update, and keep in fashion. Customer service can always be improved but typically at the expense of increased labor costs. At some level there is a point of diminishing returns where increased dollars spent in facilities and customer service do not result in a corresponding increase in play. With regard to games, relative to new facilities, new machines and models have relatively low acquisition costs. Unfortunately, all casinos have access to the same machine models. Thus, as long as all casino operators upgrade their machines to the desirable models, this method provides no competitive advantage to any single operator. With regard to incentive programs, player incentive programs can be customized by each individual operator. If successfully implemented, these programs can provide a competitive advantage. Unfortunately, many of the features of incentive programs have been widely utilized. Once all casinos adopt a particular incentive feature it no longer provides competitive advantage. Comps and player points are examples of this. Casino promotions such as drawings, giveaways, etc. are effective tools, however, none of the current promotions directly apply to a heightened gaming experience.

Embodiments of the invention address these and other deficiencies in the prior art.

### BRIEF DESCRIPTION OF THE DRAWINGS

The description may be best understood by reading the disclosure with reference to the accompanying drawings.

FIG. 1 is a functional block diagram of a game tailoring system according to embodiments of the invention.

FIG. 2 is a functional block diagram of an electronic gaming machine component of the game tailoring system shown in FIG. 1.

### DETAILED DESCRIPTION

Embodiments of a game tailoring system provide the ability to tightly integrate game and player management systems. Specifically, they provide a casino the ability to directly affect overall game behavior and interaction to build player loyalty, or to meet other business objectives. One such system can be contained in an integrated communication system including gaming machines capable of being controlled or enhanced, a gaming network coupled to the machines that includes gaming management functions, and a player management system that communicates and closely operates with the gaming management functions.

Such a game tailoring system allows a casino to design and implement a promotion targeted to a unique player group that delivers a positive, loyalty building feature in the form of changes to game content, outcomes, rules of play, and/or overall experience.

Specific embodiments of the invention allow a casino to capture data from a player/patron or groups of player/patrons. As described below, the captured data can include all facets about a player, including not only what types of games the player plays, but also how those games are played. For example, data can be gathered regarding whether the player prefers to make few, large wagers or many small wagers with their playing credits. Additionally, data can be gathered about player preferences not directly related to the games, such as how often a player stays in a casino hotel, or what purchases the player makes in a casino retail store.

Once stored, this information is analyzed to find key points of play outcomes and patron behavior that can be used as the basis for providing real-time positive feedback, to the patron's game play experience. This positive feedback would, in-turn, entice the player to follow some specific operator goals, such as coming back for an additional casino visit, wagering more money on the next visit, playing specific machines, playing at specific times, etc. Implementing these goals can be accomplished by providing rewards, such as, for instance, modifying game content, outcomes, rules of play, bonus awards, and bonus features, etc.

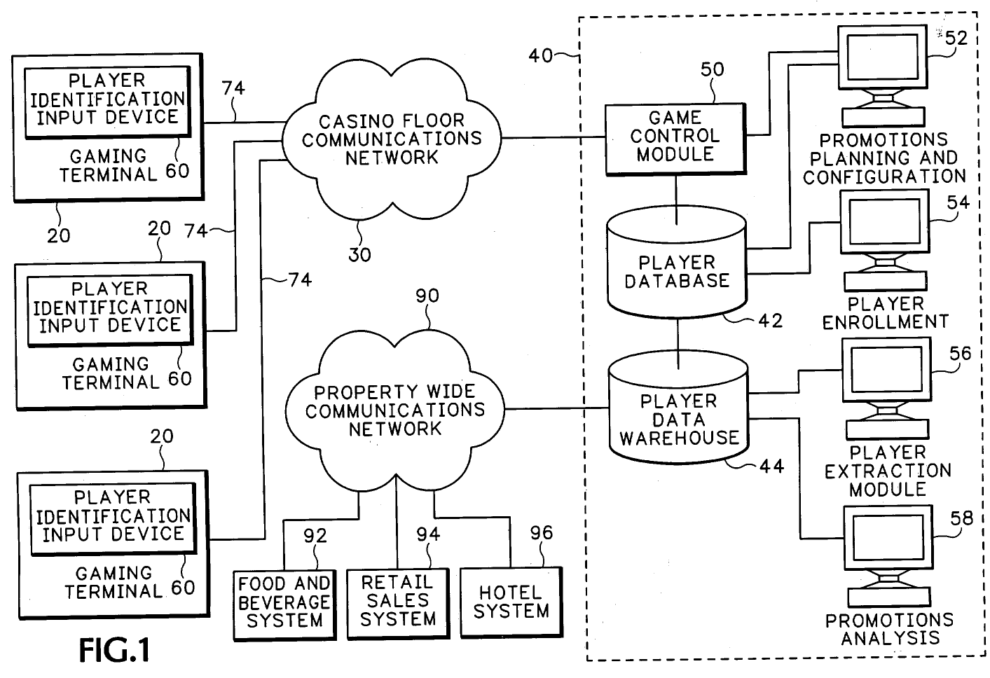

Components of one possible implementation of a game tailoring system are shown in the system diagram of FIG. 1. A series of Electronic Gaming Machines (EGMs) 20 are connected via a casino floor communications network 30 to a central computer system 40 including a patron database 42 and several player and promotional management software application modules 50, 52, 54, 56, and 58.

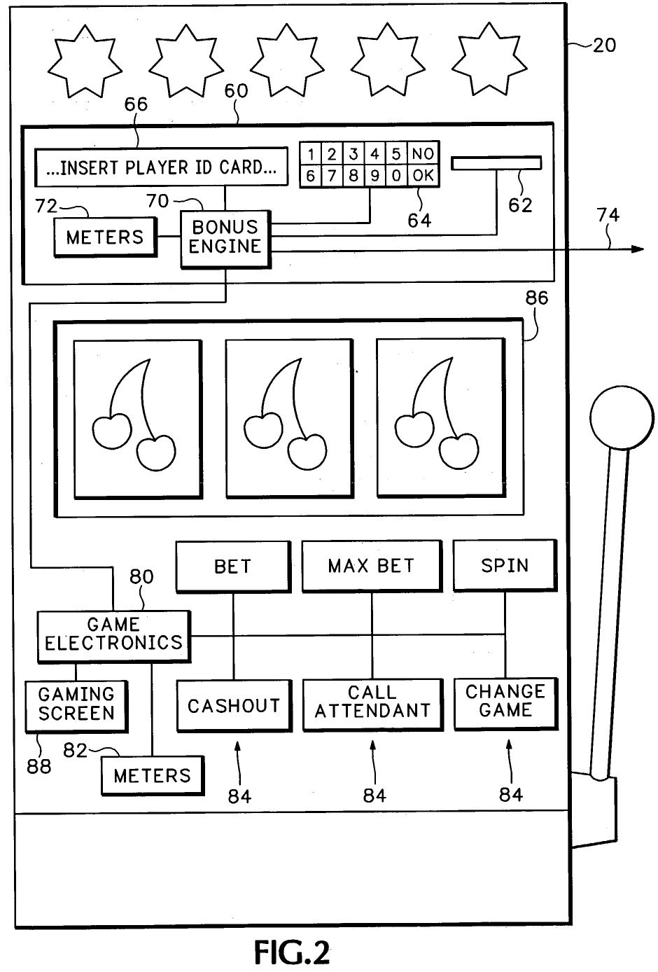

Each EGM 20 includes a player identification and tracking system 60 as a means of identifying a player at the start of a play session. This identification could be performed using a card reader to read a magnetically encoded player's card, a keypad to allow an account number or personal identification number (PIN) to be entered, biometric means, RF tags, etc. The EGM 20 would also include some means for the player to interact with the system such as a keypad, buttons, mouse, trackball, or some other device. An example EGM 20 is shown in FIG. 2. In this example, the player tracking system 60 includes a cardslot 62 in which a player card can be inserted, a keypad 64, and a display 66. The display 66 is used to communicate information about reward features to the player. The display 66 could be an existing game video screen, or a separate screen on the game, or a separate hand held unit given to each player, for instance. Because the player is the central figure in the game tailoring system, communication between the system and the player is highly important. One effective way to communicate to the player is to show the player specific promotional offers, rules of play, current status, winning notifications, etc. all directly on the game display screen 66.

Some of the messaging that can appear on the display screen 66 includes, for example: time remaining in the promotion, time elapsed in the promotion, games remaining in the promotion, games elapsed in the promotion, dollars remaining in the promotion, dollars spent in the promotion, target game outcomes hit, bonus award amount, enticing messages every x games played, earned messages—e.g. telling a player what they earned at the end of the promotion, paid messages, celebrating winning or payment of the reward, etc.

The player can additionally check the status of where they are in a particular promotion—e.g., “1 of 3 targets hit” at any time by communicating with the keypad 64 and/or display 66.

An interface, which in FIG. 2 is illustrated as a bonus engine 70, is a part of the player tracking system 60. The bonus engine 70 typically contains circuitry and processes to manage the portion of the player tracking system 60 that is mounted on the EGM 20, and for interfacing with a set of game electronics 80 within the game itself. Examples of tracking interfaces are well known and are thoroughly described in U.S. Pat. Nos. 5,655,961, 5,836,817, 5,752,882, which are incorporated herein by reference for all purposes.

In the EGM 20 illustrated in FIG. 2, a player controls the EGM by pressing various control buttons 84, which are coupled to the set of game electronics 80. Example control buttons 80 include “Bet”, “Max Bet”, “Spin”, etc. The set of game electronics 80 can also contain meters 82, such as bonus meters, which can be used to collect player data as the player plays the EGM 20. The types of data collected about the player are discussed in great detail below, but, for example, include such described data as how much the player waged, and what the outcome of a particular wager was. As the player plays an EGM 20, this data is stored in the set of meters 82, or elsewhere, and eventually transmitted back to the central computer system 40 as described below.

The bonus engine 80 may also include a set of meters 72, which may be more extensive and collect more data than the meters 82 attached to the set of game electronics 82.

As a player plays the EGM 20, data about the player, such as that mentioned above, can be sensed, and either stored in the meters 42, 62, or transmitted to a gaming/player network in real-time or near real time.

To conserve the network bandwidth required to send this information across a network, and the amount of disk space required to store this information, it may be desirable to filter the information at the EGM 20 before sending the information to the central repository in the central system 40. Information could be limited to key strategic details from each game played, or metered counts across games of key events that occur in an each game played, for instance.

Games are played, for example, by a player spinning reels of a slot type gaming device 20. In some embodiments, the reels may actually be video representations projected on a game screen 86, rather than physical reels themselves. Other embodiments of gaming devices 20 may include a separate gaming screen 88, which typically would be coupled to the set of game electronics 80.

The casino floor network 30 facilitates the transfer of information between the EGMs 20 and the central system 40. Additionally, a property communication network 90 is coupled to the central system. Nodes on the property communication network 90 can include, for instance, a food and beverage system 92, retail sales system 94, and hotel system 96. These systems and the data they generate are described in detail below.

The central system 40 includes a patron database 42 and a patron data warehouse 44. The patron database 42 could be an On-Line Transaction Processing (OLTP) database containing all information required to respond, in real-time, to the various requests for player information coming from the casino floor as various reward features are being offered to players. The patron data warehouse 44 could be an On-Line Analytical Processing (OLAP) database designed as the storage area for a wide range of historical player information described above, including gaming history, purchasing history, etc. Data in the OLAP patron data warehouse 44 is used to select candidates for various promotions, and to analyze the results of various promotions.

Interconnected with the databases 42, 44 are several application modules. A promotions planning and configuration module 52 is used to schedule promotions and set various reward feature configuration parameters. A player enrollment application module 54 is used to enroll new players and to provide real-time player status information to casino personnel. A player extraction module 56 is used to analyze historical patron information and assign patrons to various promotions. A promotions analysis module 58 is used to determine the results of promotions. Although the modules are shown as being connected to particular databases 42, 44, each of the modules can operate with data from any data available on the central system 40.

The game control module 50 is used to control elements of game play. The game tailoring system is designed to provide differing levels of game control responsibility to this module. In the extreme case, the game controller 50 controls not only the reward features but also all game functions. The EGM 20 could be an entirely “dumb” terminal. The game control module 50 determines handle game logic, determines game outcomes, and commands the terminal to display game results. In a more traditional configuration, the EGM 20 could have all responsibility for base game operation. In this case, the game control module 50 implements game logic and independently determines game outcomes.

Additionally, the game control module 50 logs indefinitely data from the promotions. For instance, for each target or trigger level reached, the game control module 50 could log: outcome attained, time attained, account number of person obtaining, coins wagered, game number, game denomination. Further, if any reward is given, the game control module 50 can log the bonus payment amount, time of payment, outcomes achieved, and game number, for instance.

Data Capturing

As an ultimate limit, a central player management system coupled to a gaming device or other data collection system could maintain a history of every game ever played by a specific patron. That history could include every detail related to every game played, including for example, amount wagered, how the wager was distributed across all possible wager options, the outcomes for any intermediate game stages, the results of any player decisions made during the game, the final game outcomes, the amount paid for each of the game outcomes, the occurrence and outcome of special bonus features, the amounts wagered on any follow-up bets such as double-ups and gambles, the amount of money transferred by the player into the machine, the amount of money transferred by the player off the machine, jackpots, handpays, bonus and other special pays.

In addition to capturing data about the player specifically based on the game, the game tailoring system can also capture details of non-gaming related activities. Because a casino can offer many services, such as a restaurant, retail store, ticket services such as concierge services, and others, data about such transactions can be collected and attributed to a player. Data such as food preferences, retail spending habits, show preferences, accommodation preferences, time of the year and duration of a stay in the casino hotel, etc. The data could be collected by recording purchases from retail outlets, restaurant and bar choices, entertainment purchases or reservations such as shows, movies, theme parks, etc., hotel records, and, if possible, data from sources outside the casino, such as income level, buying level (highest quality, cheapest price or best value). Data about Automatic Teller Machines or other withdrawals at the casinos could be recorded. Such data could be used by the game tailoring system to enhance the game enjoyment for the player.

With reference back to FIG. 1, the information collected about a player, from all sources, could be stored in the player data warehouse 44. As described above, the data could come from the EGMs 20, or from a property wide communication network 90. Player identification could be encouraged by providing an additional benefit, such as granting bonus points for every transaction, on a point per dollar, or by using another encouragement system.

One feature of embodiments of the invention is that not all EGMs 20 coupled to the game tailoring system need be always gathering data about their players, or that the EGMs be capable of the rewarding features of the game tailoring system. Further, these features are independent, such that some games could be gathering data while not participating in rewarding, or vice-versa.

Similarly, an operator of the game tailoring system can select specific players that are eligible for a specific reward, while excluding other players.

Decision Making and Triggering Events

Once information is collected about a player, the information can be quantified in a meaningful manner using common characteristics and qualities. Then, when the player next identifies himself or herself to a gaming device, or even as the current game is progressing, the game tailoring system can modify the gaming experience to customize it for that player. This customization gives the players greater enjoyment, and allows casinos and other installations to differentiate themselves. With all other factors being equal, players will patronize places they enjoy most.

Reward features granted by the game tailoring system to the individual players can be made machine or game type dependent. In other words, the reward feature offered to a player can be made to not only depend upon the historical information about that player, but also upon the game that he or she is currently playing.

The game tailoring system allows a casino to design promotions that directly effect game play. The casino can customize the gaming experience to complement their environmental offering. Some broad categories could include, for example, the ability to establish historical behavior criteria to select players to be involved in a promotion, the ability to extract players from the patron database that meet these criteria, the ability to enroll those players into the promotion, recognize when those patrons are playing, and apply the rules of the promotion to those play sessions.

A module for game control, such as that illustrated as 50 in FIG. 1 could include the ability to be modified for promotion planning and configuration. The promotion and planning module 52 can capture, and report the costs and results of each individual and collective promotion including; player communication costs, award costs, resulting increased play, trips, etc. This information can be used by a casino to determine the benefit provided to the casino by implementing the game tailoring system.

In addition to modifying game behavior based on historical player information, information gathered within the current play session can be used to modify the gaming experience. For example, in some embodiments, some reward features may only be available if players are wagering above a certain amount per game played. Other criteria could include wager denomination, where reward features may only be available, or may be substantially better if a player is playing on a higher denomination machine, such as a $5.00 game. Wager denomination could be used as a level for gathering data as well.

The amount the player wagers in a gaming session, or other time period could be used to modify reward features. For example, certain reward features are triggered only after a certain amount has been played in a session, or over a specified time period. For example, if players play $50 in a single 12 hour period, they could be allowed an extra two bonus pins.

Similarly, reward features may be triggered only as particular bets are made, for example, bets on all five lines of a multi-line slot machine, or double up bets on poker machines, or if a person only bets on 6 spots on keno machines. Or, reward features may be triggered or adjusted depending on what strategy a player uses. For example, if a video poker player always holds a low pair over four to a flush.

Other factors can include actual win/loss, where reward features are triggered or modified when person's actual losses exceed a certain amount during a session. Further, game outcomes or sets of game outcomes can be used to activate or modify a reward feature only after certain game outcomes have been attained. For example, offer an extra ace in the deck, for 5 hands after a four of a kind has been hit.

Other triggering events monitored by the game electronics 80 or the bonus engine 70 in the EGM could include, for instance: specific game outcomes, series of game outcomes, sets of game outcomes, consecutive game outcomes, X outcomes in N tries, outcome sets/unit time, and outcomes relative to others. Other triggering events monitored by the bonus engine 70, game electronics 80, or by the game control module 50 could include, for instance: points earned, win/loss per unit of time, visitation frequency, handle per unit of time, continuous play, specific player demographics, such as a player's age, residence, or gender, sets of player demographics, and series of player demographics. Still other triggers could be: lucky coin, lucky time, lucky game, and electronic drawing.

Further, the triggering events need not be related to any one particular game, session, or player. For instance, a special triggering event could be satisfied by a series of triggering events each on a different game, or by completing a series of separate triggering events on the same game or within the same timeframe. Additionally, player accounts can be “grouped” and a special triggering event occur only when all or a portion of the player accounts in a group meet individual triggering events. For example, a group could consist of 4 players, each of whom must record a full house within a 12-hour period to qualify. If all members succeeded, each player in the group could be rewarded.

Similarly, it is possible for multiple players to be assigned to the same player account. Although unusual, two or more players may desire to have only a single player account. For instance, perhaps a husband and wife are tied to the same player account. Some embodiments of the invention consider only a first player to qualify for bonuses and other promotions. Other embodiments are designed to link two player identifications to the same account, and a system operate can decide which individual balances to consider for promotions, rankings, and redemptions. Another embodiment creates a maximum number of players who can be “active” on an account at any given time. For instance, a system may allow a maximum of two cards to earn bonuses for a particular account.

A duration of a promotion can be specified. For instance, the triggering even must occur within a specified duration to satisfy the promotion criteria. Some duration examples include, for example: until all or a subset of target outcomes are attained by an individual player, for a set period of time, for a set number of games played, or for a set amount of dollars wagered. Additionally, a recurrence time of a particular promotion can be specified, such that a given 4 hour promotion operates every morning and ends at noon, without the operator specifically starting and ending the promotion, or, a promotion restarts as soon as it has been completed.

Such trigger events could be monitored by the game control module 50 in communication with the interface 70 contained in the player tracking interface 60 (FIG. 2). The game control module 50 includes processes that continuously compare the data received from the interface 70 to the current trigger events that cause certain rewards (customizations) to be granted. Once granted, the game control module 50 then sends the appropriate signals and commands to the bonus engine 70 and/or the game electronics 80 to provide the desired reward.

In addition to the game control module 50 deciding what a player will best respond to, patrons and players are able to interact with the game tailoring system to choose customization options to suit their preferences. Once selected, these options are stored in the player data warehouse 44, and recalled at the game as required.

One embodiment provides an option screen that appears when a player inserts their player card at a game. The player chooses which options he or she prefers, and the preferences are stored in the player data warehouse 44 for future reference. When the player identified himself or herself in another playing session, the game would automatically be reconfigured to meet that player's tastes. Possible options to be stored could include play speed, screen colors, language, fonts, types of bonus screens most preferred, pay schedule category (low volatility versions high volatility for example), personal progressive level assignment—e.g., I want my personal progressive to hit when I get 4 aces, assignment of personalized “special hands”—e.g., I want this certain 5 card poker hand to be my special hand. If I every get this hand I get a bonus

In operation, the player customization data could be stored in the player data warehouse 44. Then, when a player for whom customization data exists identifies himself or herself to the game tailoring network, the game control module 50 could instruct the stored data to move to the player database 42, or even to the module 50 itself.

Additionally, the trigger events and criteria to cause rewards to be generated may be adapted to change as results of such rewards are analyzed. For instance the game tailoring system can automatically determine promotion results and make appropriate modifications for improvement. For example, if a promotion had an overwhelmingly successful response, it might be appropriate to de-value the amount of the reward feature in order to reduce promotion costs while maintaining suitable effectiveness levels. Another example: It might be possible to automatically exclude patrons who aren't responding a particular style of promotion and recommend them for some other type of promotion.

Changing Gameplay

Once triggering events have been established, either by default selection by the game tailoring system, by player preferences, or by evaluating the history of the player's past games, the game tailoring system monitors gameplay and other conditions to determine when the triggering events have been met. Once met, game enhancing rewards or reward features can be generated for the player.

Characteristics of the ideal reward feature include: operation within boundaries of legal game operation defined by gaming regulations, well-defined and controllable cost, scam-proof, easy to communicate and comprehend, low cost of implementation and administration, relatively high perceived value to the target patron segment, relatively low actual cost to the casino, provides the desired effect on player behavior, i.e. increased play, increased visits, increased visits off peak time, etc.

Some categories of reward features include the following:

Direct Payments. The game tailoring system can provide direct payments made to the credit meter at the game. Many existing bonuses systems use this reward feature. One downside to using direct payments to the credit meter is that the perceived value to the player and the actual cost to the casino are exactly equal. Also, given the relatively low hold percentages in a modern casino, these payments are often perceived by the player as below the threshold required to stimulate desired behavior.

Offer Free Games, Extra Credit. The game tailoring system can provide free games or non-cashable credits that can be converted into free games by the patron. This has some additional benefit in that the actual cost to the casino is less than the perceived value to the patron.

Change the award amounts for specific events. The game tailoring system can change the award amounts. For example, multiplied jackpot time involves changing the awards by multiplying all awards won during a set time by a predefined bonus multiplier. Additionally, the game tailoring system can provide special additional awards for specific game outcomes for a certain time period or a specific number of games played. Further, the game system can provide awards to outcomes that do not typically have awards. For example, on a spinning reel machine, for a certain time period pay on blank, blank, blank; or, on a video poker “jacks or better” machine, pay on tens or better. Other possibilities include temporarily “promoting” certain outcome types to a higher award level. For example, all single bar pays now pay as double bars. Still further, other players (in addition to the player who qualified for the award) could also be given an award.

Offer awards for multiple events. The game tailoring system can offer awards based upon attaining more than one outcome. For example the system can pay additional awards for attaining sets of outcomes over multiple play sessions—e.g., if a player hits five four-of-a-kinds this week, the player wins a $100 bonus. Or, additional awards can be paid for sequential outcomes—e.g., if a player hits five low pairs in a row, the player and wins $5. Further, awards can be paid for sets of outcomes across several game types. For example players win a special bonus if they hit the 5 penguins on the Penguin Pays™ machine, the 5 Ferraris on the Reel Racers™ machine, and the 5 magic carpets on the I Dream of Jeannie™ machine.

Change the outcome probabilities. In some embodiments it is possible for the game tailoring system to increase the probability of occurrence for certain desirable game outcomes for a certain amount of time or number of games played. Possible ways to accomplish this in slot type machines include:

changing relative weighting of reel symbols

adding desirable reel symbols

deleting undesirable reel symbols

deleting reels

adding paylines

temporarily “promoting” symbols. For example, single bars are now worth double bars

temporarily making “normal” symbols wild symbols

increasing second screen bonus features.

Possible ways to accomplish this in card based games include:

adding desirable cards to the deck

deleting undesirable cards from the deck

adding wild cards or declare existing cards wild

“Promoting” cards. For example, 2s are now 2s or Aces

Possible ways to accomplish this in Keno include:

giving guaranteed “hits” in the form of hints (Pssst, number 7 will be drawn in the next round)

adding extra “balls” of specific numbers into the draw

removing “balls” from the keno draw

Change the Rules of Play. In some embodiments, the game tailoring system can temporarily change the rule of games play, in some fashion. Possible examples include, for video slot machines, allowing for the ability to re-spin selected reels to improve final outcome, or to change rules within second screen bonus features—e.g., instead of selecting from 5 possible outcomes, select from only two. In video poker, the system can allow another draw to improve final outcome for certain hand types or allow an additional wager after one or more cards are dealt.

Offer more frequent special features. Many current machines incorporate bonus features, which are triggered by any number of possible methods. Embodiments of the invention trigger cause these features to be triggered more frequently than previously.

Offer casino environmental related prizes. The game tailoring network could provide a reward feature of passes to a show in the casino, a complementary dinner in the casino restaurant, a hotel stay, or a trip to an affiliated property.

Player Points and “Comp Balances”. Most casinos offer player points, and “comp dollar” player incentives that accrue as a percentage of total dollars wagered. The game tailoring network could pay awards as additional points or comp dollars, or offer special times where accrual rates are accelerated, or redemption conversion rates are increased.

Discount Coupons. The casino can offer discount coupons to events, shows, etc.

Some types of bonus awards are described in U.S. Pat. Nos. 5,655,961; 5,836,817; 5,752,882; 5,820,459; 6,257,981; 6,319,125; 6,254,483; 6,364,768; 6,358,149; 5,876,284; 6,231,445; 6,375,569; 6,244,958; 6,431,983; 6,371,852; 6,375,567. Some or all of the types of bonus awards described in the above-listed patents can be used as rewards according to embodiments of the present invention.

Overall, to be maximally effective for the game tailoring system, game content should be easily adaptable to include casino environment related features.

Example Systems

Using the game tailoring system as shown in the figures and as described above, now illustrated are some possible examples of what information could be stored, and how it might be used as a criteria to incite play.

1) The game tailoring system can maintain counts of special hands hit by players over a defined time period. If the player hits a predefined set of target hands during the time period the player qualifies for a special positive experience in his next play session. This positive experience might be a special second screen bonus feature, or an extra spin on the bonus wheel, extra pay symbols on the reels, extra aces in the deck, or any of the other benefits described above.

2) In semi-skill based games such as video poker the game tailoring system keeps track of play decisions relative to optimum play. For example, when faced with a draw hand that has a low pair & three to a flush, the patron may make the non-optimal decision to play for the flush. The game tailoring system quantifies and accumulates this non-optimized play, which is used as a metric to decide how much to reward a player. This prevents the casino from offering substantial benefits to players who play near optimum, while allowing the casino can to offer more benefits to players who play considerably off optimum.

3)Because the game tailoring system maintains histories of specific outcomes, over time it provides a loyalty-building award triggered when a player has an overly long “dry spell”. For example, if a particularly desirable game outcome has a frequency of 1 in 400 games and a player doesn't get this particular outcome after playing for 10,000 games. The system offers the player a special play period during which lesser outcomes are artificially promoted to this more desirable outcome.

4) In another example, the game tailoring system maintains the occurrence of target hands by player for a particular group, or team of players. This team of players then competes against another team of players. The system awards a prize to the group with the greatest number of target hands over a specified time period.

5) The system can maintain detailed records of spend per visit. Then, if the player agrees to exceed his average spend per visit by x on his next visit, the system offers some enticing play feature, an extra bonus symbol on the reel, or an extra spin of the wheel on certain conditions,

6) The system can record and track player behavior relative to money management. For example, a player might tend to end a play session when the amount of accumulated credits exceeds his initial buy-in by a factor of ten. When this condition occurs, the game tailoring system offers a special enticement if the player continues play.

7) By tracking details of game types and models played, the game tailoring system can determine the “volatility level” preferred by the customer. For example some patrons prefer highly volatile games with paybacks that center around low frequency—high prize value awards. Others prefer games with low volatility. Because the system already stores this information, either by requesting the information directly from the player, or by monitoring the players gaming history, the system can automatically configure the nature of the incentive rewards to meet the player's desires. For example, the high volatility seeker might appreciate an award which would give him a perceived “edge” in attaining desired target outcomes, which could be an extra “ace in the deck” for example on a Aces bonus poker.

8) By tracking particular game outcomes (e.g. four of a kind), jackpots or prizes can be offered for particular combinations of game outcomes achieved over a defined period of time (e.g. an award to the first player in October that gets five independent four of a kind hands that are sequential, such as four threes, four fours, four fives, four sixes and four sevens).

Costs to implement a game tailoring system such as that described above could be offset by increased player revenue. Specifically, because of the heightened gaming experience, more players will play a game tailoring system than a regular system. Additionally, players will be willing to spend more for the increased gaming experience.

One method to determine and control the exact costs of reward features could be to use a pool based method. In this method, pools are accrued as a percentage of coin in from a single player or a group of players. Awards are deducted from the pool. Awards size and frequency are governed by pool size. A simple example would be, if the pool is greater than zero, awards are paid. If the pool is less than zero, awards are not paid.

Another method to control cost is the fixed amount method. Using this method, a fixed amount of can be set per person, per player group, per machine group, per certain time period, or per number of games played. Promotions are designed to expire when this fixed amount has been exhausted.

In another method, a theoretical expected value is calculated. For reward features that affect game rules, outcome probabilities, or tie awards to specific game outcomes it is possible to compute, a priori, the theoretical expected value of the percentage of money wagered that will be returned to the player in the form of prizes that result from the reward feature. Once this value is known, the casino can: reduce the payback of the “base game” to compensate for the increased payback associated with the reward feature, reduce payback associated with other bonus features, or keep payback of the base game and other bonuses constant and assume that reward features will be funded by increased play that results from promotion.

Reward features in the game tailoring system are always built with a specific objective relating to player behavior. Examples include increased player visits, increased money wagered per visit, increased play on machines that provide better hold percentages for the casino, and increased play on higher denomination machines.

The system can be structured to automatically evaluate the response of those patrons enrolled in a specific promotion. The system provides the casino with the ability to measure the actual results with the intended results. The system can also measure the costs associated with promotion implementation and reward features. With this information, the system determines the final financial impact of a promotion.

Although examples of machines and processes have been described herein, nothing prevents embodiments of this invention from working with other types of machines and processes. Implementation of the game tailoring system is straightforward to implement in light of the above description. As always, implementation details are left to the system designer. Inclusion of description or illustration of a function in either the gaming device or the remainder of the system is not dispositive that the function is located in or must be performed there.

Thus, although particular embodiments for a game tailoring system has been discussed, it is not intended that such specific references be considered as limitations upon the scope of this invention, but rather the scope is determined by the following claims and their equivalents.

What is claimed is:

1. A game tailoring system for a gaming terminal playable by a user identifiable to the system, the system comprising:
a player tracking system coupleable to the gaming terminal and structured to record data of a play history of an identified game user playing the gaming terminal; and
a player management system structured to provide, based on identical gameplay of two different identified players, different rewards to the two players based on the respective recorded data of the two players.

2. The game tailoring system of claim 1, wherein the player tracking system is further structured to record non game-play data about the identified game user.

3. The game tailoring system of claim 2 wherein the non gameplay data comprises purchase data.

4. The game tailoring system of claim 1 wherein the player management system is structured to cause the gaming terminal to change gameplay.

5. The game tailoring system of claim 4 wherein the player management system is structured to change game content.

6. The game tailoring system of claim 4 wherein the player management system is structured to change rules of a game on the gaming terminal.

7. The game tailoring system of claim 1 wherein the player management system is structured to make direct payments.

8. The game tailoring system of claim 7 wherein the direct payments are made to a player account.

9. The game tailoring system of claim 7 wherein the direct payments are made to a credit meter of the gaming terminal.

10. The game tailoring system of claim 7 wherein the direct payments are made to a bonus meter of the gaming terminal.

11. The game tailoring system of claim 7 wherein the direct payments are free games.

12. The game tailoring system of claim 1 wherein the player management system is structured to classify groups of identified players.

13. The game tailoring system of claim 1 wherein the player management system is structured to generate an award based on a condition meeting a triggering event.

14. The game tailoring system of claim 13 wherein different players can have different triggering events.

15. The game tailoring system of claim 13 wherein the player management system is structured to send player preferences to the gaming terminal when a player is identified.

16. The game tailoring system of claim 1 wherein the player tracking system is structured to track specific events of the play history of a particular user.

17. The game tailoring system of claim 16, wherein the tracked portion of the play history comprises only significant events.

18. The game tailoring system of claim 17 wherein a significant event comprises large wins.

19. The game tailoring system of claim 17 wherein a significant event comprises a particular win that occurs less often than one in three overall wins.

20. The game tailoring system of claim 17 wherein a significant event comprises a cashout.

21. The game tailoring system of claim 17 wherein a significant event comprises a buy-in.

22. The game tailoring system of claim 1 wherein the player tracking system is structured to track all game outcomes.

23. The game tailoring system of claim 1 wherein the player tracking system is structured to store data about a player over an accumulated number of gaming sessions.

24. The game tailoring system of claim 16 wherein the player tracking system is structured to store data of rewards only greater than a threshold amount.

25. The game tailoring system of claim 24 wherein the player tracking system is structured to store data of a plurality of different awards.

26. A game tailoring system for a gaming device playable by a user identifiable to the system, the system comprising:
a player tracking system coupleable to the gaming device and structured to record data of a personal preference of an identified game user; and
a player management system structured to cause the personal preference to be effected at the gaming device.

27. The game tailoring system of claim 26 wherein the player management system is structured to load the personal preference to the gaming device when the user identifies himself of herself.

28. The game tailoring system of claim 26 wherein the personal preference is language selection.

29. The game tailoring system of claim 26, wherein the gaming device includes a display screen controllable to show users a set of potential preferences.

30. On a player tracking network coupled to a gaming terminal having a gaming display, a method for displaying content on the gaming display, comprising:
generating the content to be displayed on the gaming display;
pre-storing the generated content on the player tracking network; and
when a triggering event occurs,
retrieving the pre-stored content, and
transmitting the pre-stored content to the gaming terminal.

31. The method of claim 30 wherein the playing tracking network is coupled to a plurality of gaming terminals, each having a respective display, the method further comprising:
selecting one or more of the plurality of displays; and
transmitting the pre-stored content only to the selected one or more displays.

32. The method of claim 31 wherein selecting one or more of the selected plurality of displays is based on a location of its respective gaming terminal.

33. The method of claim 31 wherein selecting one or more of the plurality of displays is based on identity of a player playing at the gaming terminal.

34. The method of claim 30 wherein the playing tracking network is coupled to a plurality of gaming terminals, the method further comprising:
selecting a first and a second group of the plurality of terminals;
transmitting a first set of pre-stored content to the first group; and
transmitting a second set of pre-stored content to the second group.

35. The method of claim 34 wherein selecting a first and a second group of the plurality of terminals is based on a group of players.

36. The method of claim 30 wherein the content comprises text.

37. The method of claim 30 wherein the content comprises graphics.

38. The method of claim 30 wherein the content is animated.

39. The method of claim 30 wherein the triggering event is a bonus event.

40. The method of claim 30 wherein the triggering event is a player activity.

41. The method of claim 30 wherein the triggering event is caused by the gaming terminal.

42. The method of claim 30 wherein the triggering event is different for different players.

43. The method of claim 42 wherein the triggering event is based on data stored in the player tracking system.

44. The method of claim 30 wherein the gaming terminal has two gaming displays, and wherein the content can be displayed on either or both of the gaming displays.

45. A player tracking system structured to be coupled to a plurality of gaming terminals, the player tracking system comprising:
a first selector structured to select a group of gaming terminals from the plurality of gaming terminals;
a second selector structured to select a group of players identified to the player tracking system; and
a rewarder structured to provide a reward to a selected of the group of players if the selected player is playing at a gaming terminal within the selected group of gaming terminals.

46. The player tracking system of claim 45 wherein the selected of the group of players is a first in the group of players to qualify for a reward.

47. The player tracking system of claim 45 wherein the rewarder is structured to provide a first reward to a first player in the group of players to qualify for the first reward, and structured to provide a second reward to a second player in the group of players to qualify for the second award.

48. The player tracking system of claim 47 wherein the first and second awards are the different awards.

49. The player tracking system of claim 48, further comprising a data tracker structured to track gameplay data from the selected group of terminals.

50. The player tracking system of claim 45, further comprising a data tracker structured to track gameplay data about the selected group of players.

51. The player tracking system of claim 50 wherein the tracked gameplay data is stored in the player tracker system.
